(19) United States
(12) Patent Application Publication
(10) Pub. No.: US 2022/0176626 A1
(43) Pub. Date: Jun. 9, 2022

(54) METHOD AND DEVICE FOR BUILDING UP A COMPONENT IN LAYERS FROM PHOTOPOLYMERIZABLE MATERIAL

(71) Applicant: Lithoz GmbH, Vienna (AT)

(72) Inventors: Michael SCHMID, Vienna (AT); Lukas EMMINGER, Raggendorf (AT); Sebastian GEIER, Vienna (AT)

(21) Appl. No.: 17/538,772

(22) Filed: Nov. 30, 2021

(30) Foreign Application Priority Data
Dec. 3, 2020 (EP) 20020586.2

(51) Int. Cl. B29C 64/188; B29C 64/245; B29C 64/232; B29C 64/124; B29C 64/264; B33Y 10/00; B33Y 30/00; B33Y 40/20

(52) U.S. Cl. CPC B29C 64/188; B29C 64/245; B29C 64/232; B33Y 40/20; B29C 64/264; B33Y 10/00; B33Y 30/00; B29C 64/124

(57) ABSTRACT

In a method of building up a component in layers from photopolymerizable material, in particular a resin with ceramic or metallic filler, in which component layers are successively formed one above the other by forming a layer of the highly viscous photopolymerizable material between a building platform or the component and a material carrier, which is cured in a location-selective manner to form the desired shape of the component layer, a cleaning step takes place after the component layer has been formed, in which uncured photopolymerizable material adhering to the component layer is removed by means of a cleaning unit after the component has been lifted.

The invention relates to a method for building up a component layer by layer from photopolymerizable material, in particular a resin with ceramic or metallic filler, in which component layers are successively formed one on top of the other by a material layer of the photopolymerizable material being formed on a material carrier and the building platform or the component at least partially built up on the building platform being lowered into the material layer, so that a layer of the photopolymerizable material is formed between the building platform or the component and the material carrier, which is cured in a location-selective manner in particular by irradiation through the material carrier to form the desired geometry of the component layer, after which the component with the component layer is lifted.

The invention also relates to a device for carrying out the method according to the invention.

A method and a device of the type mentioned at the beginning are described in WO 2010/045950 A1 and in EP 2505341 A1. The method is used to build up a component in layers using lithography-based additive manufacturing, for example rapid prototyping. In this case, a defined layer of photopolymerizable material, which is located on a material carrier that is at least partially transparent to light, is formed in the following manner. A vertically controlled movable building platform is supported by a lifting mechanism so that it can be raised and lowered vertically by the lifting mechanism under the control of a control unit. By lowering the building platform into the photopolymerizable material, material is displaced from the space between the underside of the building platform and the material carrier. By precisely adjusting the vertical position of the building platform, a layer of photopolymerizable material can be produced between the underside of the building platform and the material carrier with a precisely defined layer thickness. The layer of photopolymerizable material defined in this way is then exposed to the desired geometry by means of location-selective exposure from below through the translucent material carrier, in order to thereby cure the layer on the building platform. The building platform with the first layer cured on it is then raised and photopolymerizable material is fed into the exposure area on the material carrier. These steps are repeated in order to build up the component from successive layers, but the layer of photopolymerizable material is now not defined by the building platform, but by the unfinished component.

The method described above is particularly suitable for processing photopolymerizable material with high viscosity. A high viscosity of the material can be observed, for example, in the case of ceramic-filled photopolymerizable material. The high viscosity of the photopolymerizable material causes a considerable deterioration in processability in lithography-based additive manufacturing. When a highly viscous material is mentioned in the context of the present invention, this refers in particular to a viscosity of at least 10 Pa·s.

After a component layer has cured, when the component is lifted from the material on the material carrier, uncured photopolymerizable material remains adhering to the component. The non-cured photopolymerizable material adheres in particular to the component layer that was built up last. As a result, at the end of the construction process, the component is surrounded by a viscous layer of uncured photopolymerizable material, which has to be removed at great expense during post-processing. Another disadvantage of the adhering material is that it is not possible to produce components with closed geometries, such as closed cavities (e.g. spheres), since these would undesirably contain uncured photopolymerizable material in the cavities.

It is therefore the object of the present invention to improve a method and a device of the type mentioned at the beginning with a view to overcoming the disadvantages mentioned.

To achieve this object, the invention essentially provides for a method of the type mentioned at the outset, wherein, after the formation of a component layer, a material removal step takes place in which, after the component has been lifted, not or not completely cured photopolymerizable material adhering to the component, in particular to the component layer, is at least partially removed by means of a material removal unit, whereupon the component is possibly lowered again for the next building step.

In the context of the invention, the terms “lower” and “lift” do not imply a specific direction of movement, such as a vertical movement, but encompass any movement in which the component moves in the direction towards the material carrier (“lowered”) and away from it (“lifted”). For example, the lowering can include the immersion of the component in the material layer and the lifting of the component can include the emersion of the component layer formed from the material.

Because adhering material is at least partially removed after a component layer has been formed, the effort for post-processing the finished component is reduced.

Adhering, uncured photopolymerizable material is preferably removed after the formation of each component layer, so that at the end of the construction process a component is actually obtained to which significantly less or ideally no uncured material residues adhere.

The removal of adhering material also opens up the possibility of manufacturing components with closed cavities that contain significantly less uncured material.

According to the invention, the material is removed with the aid of a material removal unit, preferably by means of an automatic material removal unit, so that manual work steps can be avoided during the construction process. The material removal is advantageously carried out in such a way that the material removal unit is approached to the underside or the lower edge of the component after the component has been lifted and/or, conversely, the component is approached to the material removal unit, with the approach preferably taking place automatically and is controlled by a electronic control unit.

According to a preferred embodiment of the invention, the material removal step comprises bringing the adhering photopolymerizable material into contact with a contacting element, preferably an absorbent, in particular flat contacting element. The absorbent contacting element can be, for example, a cellulose tape, a paper, a film, a fleece or a sponge. The bringing into contact takes place on the basis of a relative movement between the component and the absorbent contacting element. The absorbent flat contacting element and the component layer with the adhering material can be brought into contact with one another, for example, in a relative movement running transversely, in particular perpendicular, to the plane of the component layer. In this case, the material is removed in the manner of dabbing the component layer, with the uncured material adhering in particular to the edge of the component layer remaining adhered to the absorbent contacting element. After the at least partial removal of the uncured material, the absorbent contacting element and the component are spaced apart so that the component can be lowered again into the material on the material carrier for the next building step.

The contacting element can alternatively have a curved, in particular cylindrical, absorbent surface, so that the material is removed by rolling the curved surface on the component. The contacting element can be designed as a roller, for example. For this purpose, the contacting element is preferably mounted rotatably about an axis of rotation of the arcuate, in particular cylindrical, surface.

According to a preferred procedure, the material removal unit for the material removal step is brought between the lifted component and the material carrier. This means that the building platform together with the unfinished component formed on it only has to be displaced in the height direction for the material removal step, it being possible to maintain the lateral alignment of the component to the material carrier and the exposure unit.

Alternatively, however, it can be provided that the component for the material removal step is rotated to the side after it has been lifted.

According to an advantageous development, the absorbent flat contacting element is designed as a movable belt, the belt being moved after a material removal step in order to convey away a belt section with photopolymerizable material and provide a new belt section for a further material removal step. The movable belt can be kept in stock on a supply roll. Preferably, the belt is successively unrolled from a supply roll and the used tape is rolled up onto a receiver roll to the extent of the unwinding. The belt can be kept with tension in the area between the supply roll and the receiver roll with the aid of motors, for example servomotors. In the area of contact with the component, the movable belt can be supported by a support element on the side facing away from the component in order to be able to apply a counterpressure. The support element preferably provides an elastically flexible support surface, so that when it comes into contact with the component, counterpressure is generated, but the movable belt also yields due to the pressure of the component layer, which leads to a slight inclination of the belt in the edge area of the component layer the material, which in turn results in that material removal in the edge area or on the side surfaces of the component layer is improved. The flexible support element can for example be formed by a sponge.

The movable belt can be formed, for example, from a paper, a film, a fabric, a felt or a fleece.

According to a preferred procedure, the material removal step is carried out in at least two steps, with a partial amount of the adhering photopolymerizable material being removed in a first step and a remaining amount of the adhering photopolymerizable material being removed in a second step and optionally at least one further step.

In order to improve the removal of material, a preferred embodiment provides that the absorbent contacting element is impregnated with a liquid or is provided with a liquid, preferably a solvent, before it is brought into contact. The solvent then comes into contact with the material to be removed and dissolves it from the component layer.

Another preferred embodiment provides that after the material removal step and before the next building step, particles are applied to the component layer, the particles preferably being transported to the component layer with the absorbent contacting element and applied to the component layer by bringing the absorbent contacting element into contact with the component layer. In this way, particles can be integrated into the component. The particles can have any shape, such as spherical, oval or fiber-shaped particles. The introduced particles can be, for example, (ceramic) short or continuous fibers, metallic particles or porogens.

Another advantage of the material removal step according to the invention is that, after the material removal step, the component layer can be subjected to an optical inspection by means of an image recording device or a 3D scanner. As a result, the construction progress can be monitored during the construction process, in particular the geometry of the component layer produced last being checked or the presence of air bubbles in the component layer being able to be detected. Such a quality assurance would not be possible without the material removal step according to the invention, because uncured adhering material at least partially covers the component layer that was last built up.

Another essential advantage of the material removal step according to the invention is the possibility of building a component from two or more different photopolymerizable materials without significant cross-contamination between the respective material supplies on the material carrier.

The material can be changed from one layer to the other layer, for example. For this purpose, the procedure is preferably such that a first component layer is formed from a first photopolymerizable material and that, after the material removal step to remove the first photopolymerizable material adhering to the first component layer, a second component layer is formed from a second photopolymerizable material, which is different from the first photopolymerizable material.

However, it is also possible to proceed in such a way that two different materials are used within one and the same component layer. A preferred procedure here provides that a component layer with a first geometry is formed from a first photopolymerizable material, wherein the first geometry leaves uncovered at least a sub-area of the bottom side of the component layer formed last, wherein first photopolymerizable material adhering to the component layer and to the at least one uncovered sub-area is removed by means of the material removal step and that a building step is then carried out with a second photopolymerizable material that differs from the first photopolymerizable material, the building step comprising curing material in the sub-area.

For the material change, the procedure is preferably such that two or more material carriers are provided for different photopolymerizable material, which can be selectively positioned between the building platform or the component and the exposure unit after the component has been lifted.

An alternative possibility for material removal is a fluidic or pneumatic material removal. A preferred embodiment provides that the material removal step comprises creating a fluid flow, such as a liquid or gas flow, in the area of the adhering, uncured photopolymerizable material which carries the material along with it.

Alternatively, the material can also be removed by immersing the component in an ultrasonic bath.

In order to form the individual material layers for the component layers to be produced one after the other, the procedure is preferably such that the building platform is raised after the curing step and is lowered again to the material carrier to form the next component layer, after material has been fed under the raised building platform to form the material layer.

The material is supplied in this context preferably by means of material distribution with the aid of a doctor blade, the layer thickness of the material layer being adjusted by adjusting the distance between the lower edge of the doctor blade and the surface of the material carrier facing the material.

The method according to the invention is particularly suitable for processing highly viscous, photopolymerizable material, such as, for example, a resin with a ceramic or metallic filler. A highly viscous material is understood here to mean a material that has a viscosity of at least 10 Pa·s at a temperature of 20° C.

According to a further aspect of the invention, a device for performing the method according to the invention is provided, comprising
a material carrier for photopolymerizable material, which is at least partially translucent,
a building platform which is held at an adjustable height above the material carrier,
an irradiation unit which can be controlled for the location-selective irradiation of a material layer formed between the underside of the building platform and the material carrier, whereby a component layer can be generated,
a material removal unit for at least partial removal of uncured photopolymerizable material adhering to the component, in particular to the component layer, after it has been lifted.

The device preferably further comprises a doctor blade held at an adjustable height and/or with an adjustable inclination above the material carrier for forming the material layer on the material carrier, an actuator unit being provided for height adjustment.

The material removal unit preferably comprises a contacting element, preferably an absorbent, in particular flat contacting element, which is arranged to be brought into contact with the adhering photopolymerizable material.

The material removal unit is preferably arranged displaceably in order to be brought between the lifted component and the material carrier for the material removal step. In particular, the material removal unit can be moved in the horizontal direction, i.e. parallel to the plane of the component layers, in order to be brought between the lifted component and the material carrier. As soon as the material removal unit comes to rest between the lifted component and the material carrier, in the case of a material removal unit that works on the principle of contact-based material removal, the material removal unit and the uncured material adhering to the component are brought into contact. For this purpose, either the component can be moved vertically downwards in the direction towards the material removal unit or the material removal unit can be moved vertically upwards in the direction towards the component.

According to an alternative embodiment, the building platform, is rotatably held in order, for the material removal step, to rotate the component to the side after it has been lifted. In this case, the material removal unit is positioned to the side of the building platform and the material removal unit is brought into contact with the component in a position of the component that is pivoted to the side.

It is preferably provided that the absorbent flat contacting element is designed as a movable belt. The absorbent contacting element can be, for example, a cellulose tape, in particular a low-lint cellulose tape.

According to a further preferred embodiment, the material removal unit has an applicator for applying a solvent or particles to the absorbent contacting element. The applicator can comprise a drop applicator or a spray device for applying a solvent.

According to a preferred embodiment, the device, for control purposes, comprises
an electronic memory for a virtual three-dimensional model of the component layers and the component built from them,
a control unit to which the virtual model of the component layers is fed and which is designed to polymerize superimposed component layers on the building platform in successive irradiation steps with a predetermined geometry by controlling the irradiation unit and to control the material removal unit for performing the material removal step.

The invention is explained in more detail below with reference to exemplary embodiments shown schematically in the drawing. In the drawings

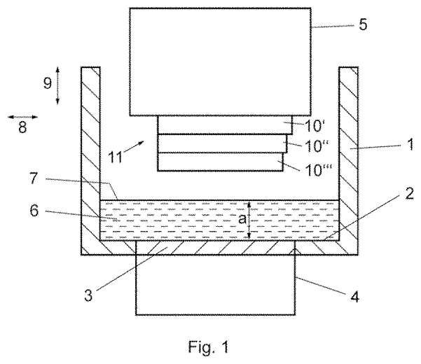

FIGS. 1 to 3 show a sectional view of a device for building up a component in layers in successive phases of the process sequence,

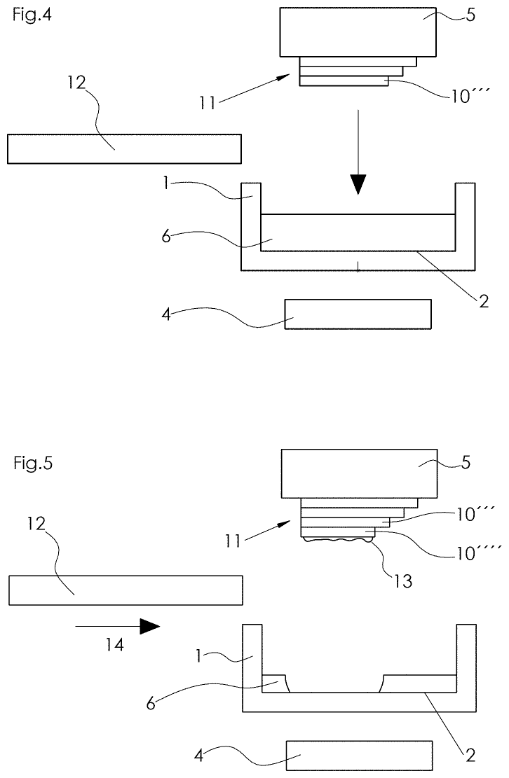

FIGS. 4 to 11 show the process of a material removal according to the invention,

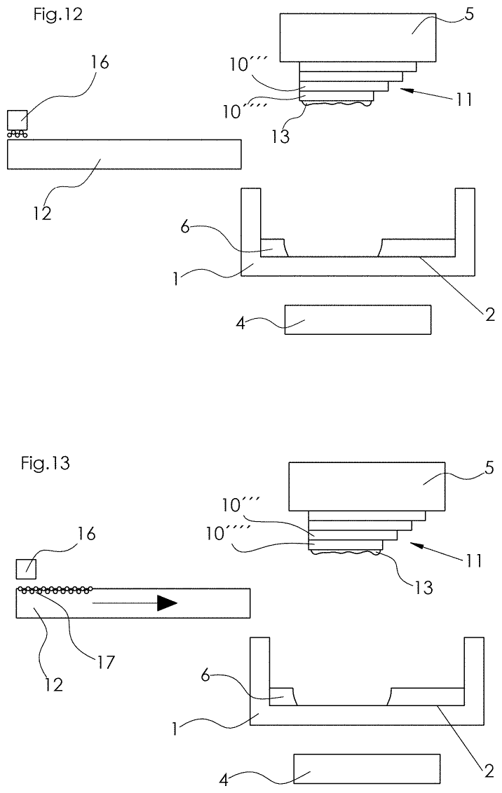

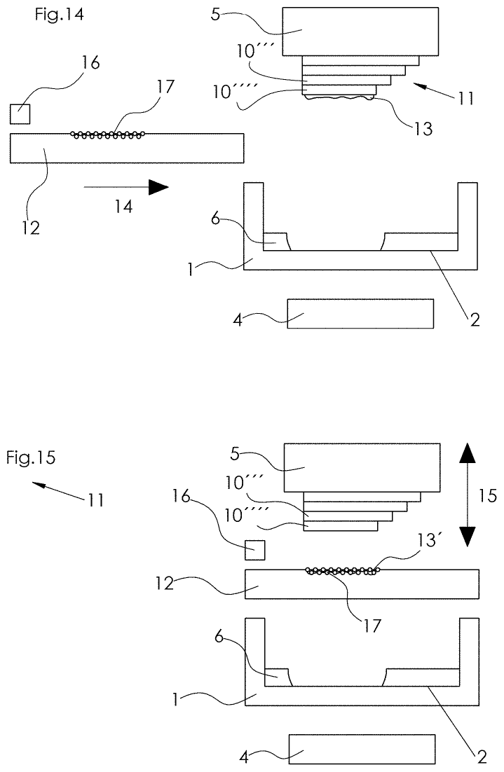

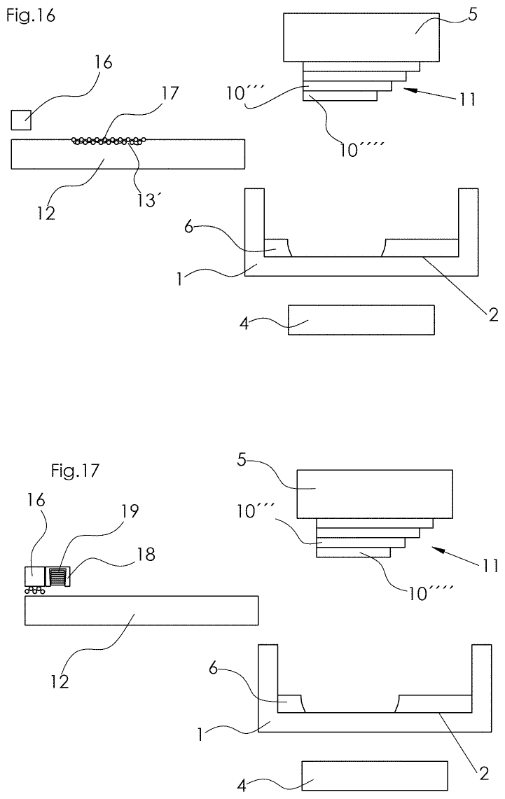

FIGS. 12 to 16 show the process of a modified embodiment of the material removal according to the invention,

FIGS. 17 to 21 show the process of particle application according to the invention,

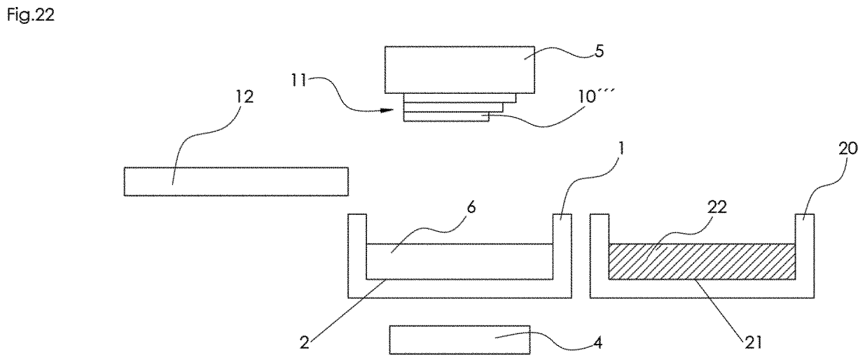

FIGS. 22 to 31 show the process of a modified embodiment of the material removal according to the invention,

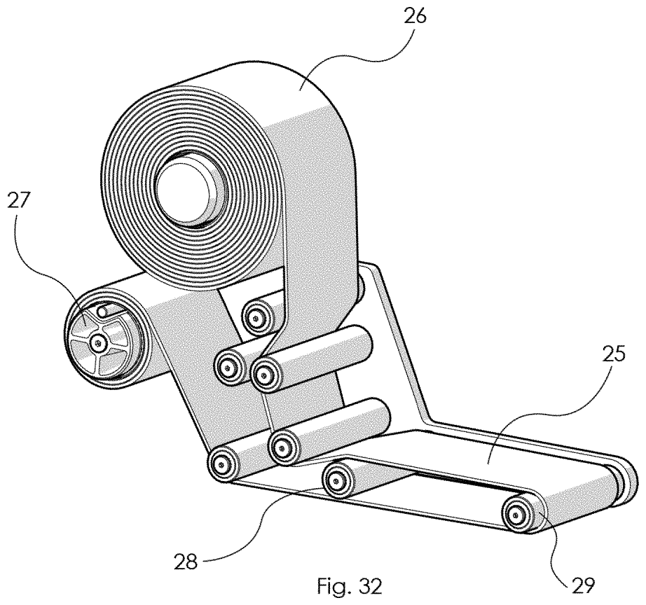

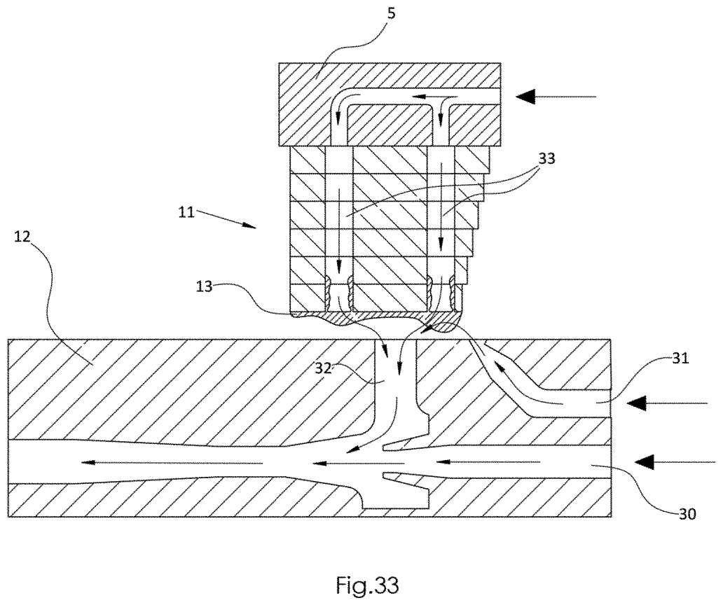

FIG. 32 shows an embodiment of a belt-shaped material removal unit, and FIG. 33 shows an alternative embodiment of a material removal unit.

A method and a device for building up a component in layers from photopolymerizable material will first be described with reference to FIGS. 1 to 3, this being a device already known in principle from EP 2505341 A1. The device located in air or another gas atmosphere has a trough 1, the trough bottom of which forms a material carrier 2 which is transparent or translucent in at least a partial area 3. This partial area 3 of the material carrier covers at least the extent of the area that can be irradiated by the exposure unit 4, the exposure unit 4 being arranged below the material carrier 2. The exposure unit 4 has a light source (not shown) and a light modulator with which the intensity can be controlled by a control unit and set in a location-selective manner in order to generate an exposure field on the material carrier 2 with the geometry desired for the layer currently to be formed. Alternatively, a laser can also be used in the exposure unit, the light beam of which successively scans the exposure field with the desired intensity pattern via a movable mirror which is controlled by a control unit.

Opposite the exposure unit 4, a building platform 5 is provided above the material carrier 2, which is carried by a lifting mechanism (not shown) so that it is held in a height-adjustable manner above the material carrier 2 in the area above the exposure unit 4. The building platform 5 can also be transparent or translucent.

A bath of highly viscous photopolymerizable material 6 is located on the material carrier 2. The material level 7 of the bath is defined by a suitable element, such as a doctor blade, which applies the material uniformly to the material carrier 2 in a certain material layer thickness a. The trough 1 can, for example, be assigned a guide rail on which a carriage is guided displaceably in the direction of the double arrow 8. A drive ensures the back and forth movement of the carriage, which has a holder for a doctor blade. The holder has, for example, a guide and an adjusting device in order to adjust the doctor blade in the direction of the double arrow 9 in the vertical direction. The distance between the lower edge of the doctor blade and the material carrier 2 can thus be adjusted. The doctor blade is used when the building platform is in the lifted state as shown in FIG. 1, and serves to distribute the material 6 evenly while setting a predetermined layer thickness. The layer thickness of the material 6 resulting from the material distribution process is defined by the distance between the lower edge of the doctor blade and the material carrier 2.

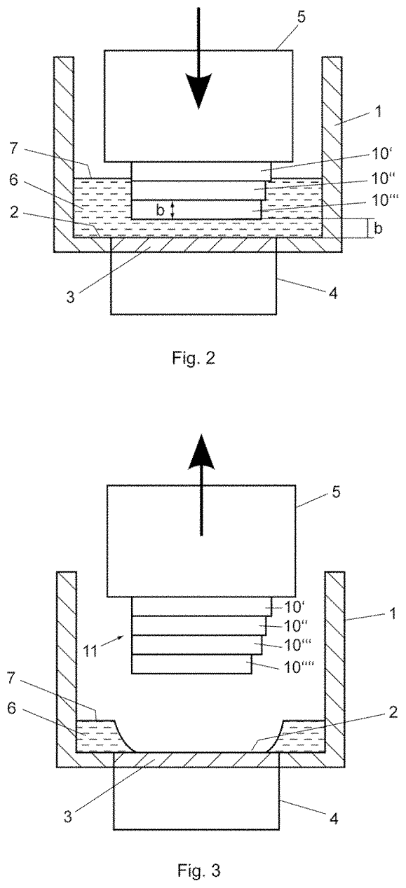

The resulting material layer thickness a is greater than the component layer thickness b (FIG. 2). The following procedure is used to define a layer of photopolymerizable material. The building platform 5, on which component layers 10′, 10″ and 10′″ have already been formed, is lowered in a controlled manner by the lifting mechanism, as shown in FIG. 2, so that the underside of the lowermost component layer 10′″ first touches the surface of the material 6 having height a, then dips and approaches the material carrier 2 so far that exactly the desired component layer thickness b remains between the underside of the lowermost component layer 10′″ and the material carrier 2. During this immersion process, photopolymerizable material is displaced from the space between the underside of the lowermost component layer 10′″ and the material carrier 2. As soon as the component layer thickness b has been established, the location-selective exposure specific for this component layer takes place in order to cure the component layer 10″″ in the desired shape. After the component layer 10″″ has been formed, the building platform 5 is raised again by means of the lifting mechanism, which brings about the state shown in FIG. 3. The photopolymerizable material 6 is no longer present in the exposed area.

These steps are then repeated several times in order to obtain further component layers made of photopolymerizable material. The material no longer present in the exposed area is replaced by restoring the material level 7 or the material layer thickness a. The distance between the underside of the component layer 10″″ last formed and the material carrier 2 is set to the desired component layer thickness b and the photopolymerizable material is then cured in the desired manner in a location-selective manner.

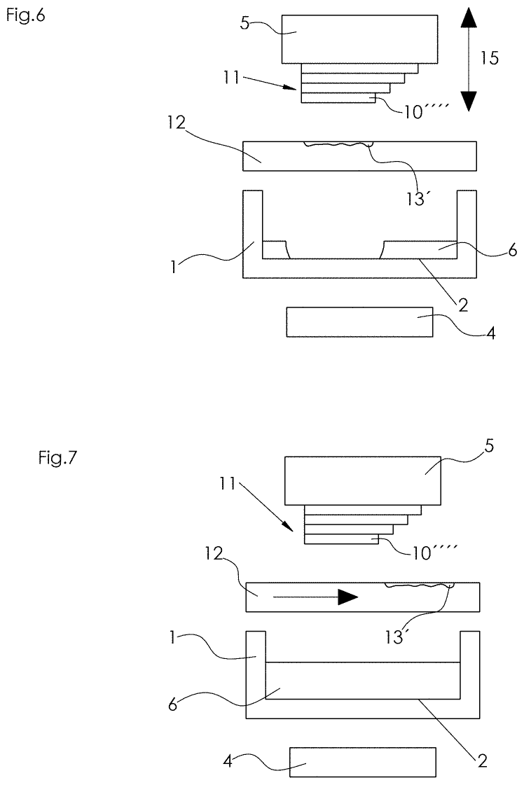

When the building platform is raised, a quantity 13 of an uncured photopolymerizable material 6 remains adhering to the component, in particular to the component layer 10″″ built up last. According to the invention, the device therefore comprises a material removal unit 12, as shown in FIGS. 4 to 11. FIG. 4 shows the device before the component layer 10″″ is formed. The material removal unit 12 is positioned in its starting position next to the trough 1 and can be moved in the horizontal direction in the direction of the arrow 14 (FIG. 5). Adhering material 13 is now at least partially removed after the component layer 10″″ has been formed, in that the material removal unit 12 is initially brought between component 11 and trough 1 with the building platform 5 being lifted. Then the component layer 10″″ last produced and the material removal unit 12 are brought into contact by a relative movement in the direction of the arrow 15, so that the uncured material 13 adhering to the bottom and possibly the side surface of the lowermost component layer 10″″ is at least partially transferred to the material removal unit 12, so that the amount of material 13′ gets onto the material removal unit 12, as shown in FIG. 6. The amount of material 13′ is transferred to the material removal unit 12, for example, by the capillary action of an absorbent material in the material removal unit 12. A relative movement then takes place in order to separate the component from the material removal unit.

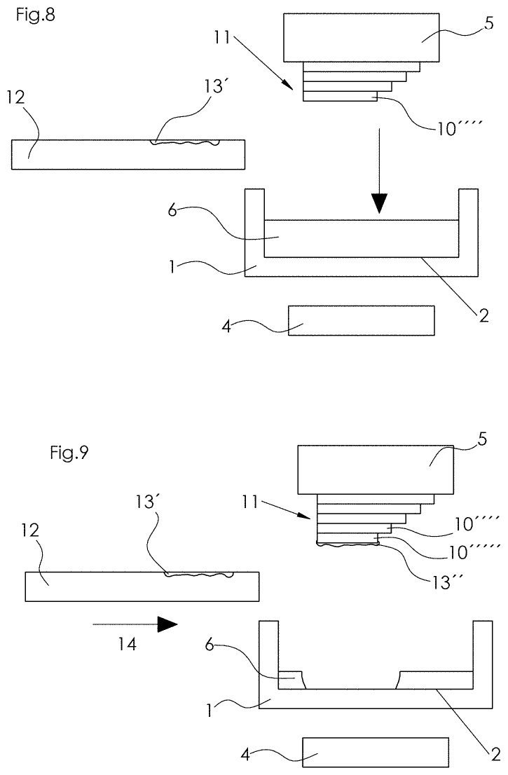

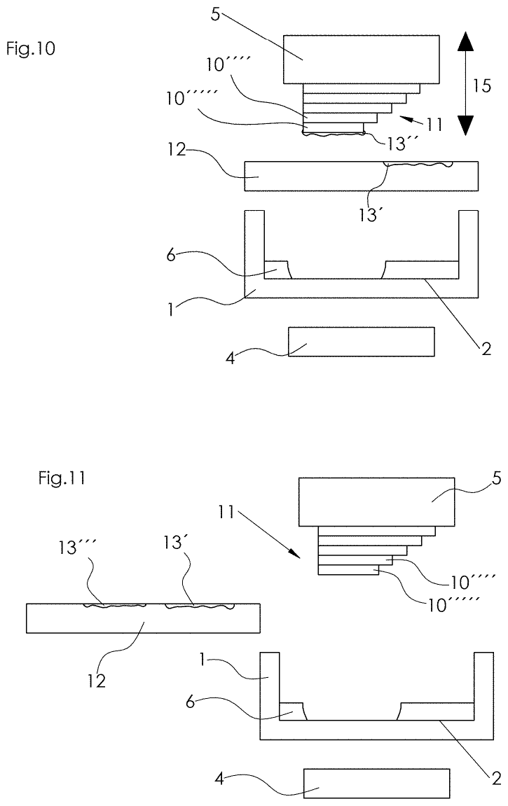

After this material removal step, a surface section of the material removal unit 12 is moved a little further in order to convey the removed amount of material away from the component layer 10″″ and to provide a new surface section of the material removal unit 12 for a further material removal step, as shown in FIG. 7. The material removal unit 12 is then brought back to its starting position (FIG. 8) so that a further component layer 10′″″ can be formed, to which in turn a quantity of material 13″ adheres (FIG. 9). The material removal unit 12 is moved between component 11 and trough 1 for the next material removal step and the amount of material 13′″ is transferred to the material removal unit 12 as described above (FIG. 10). Finally, the material removal unit 12 is brought into its starting position (FIG. 11) and the next component layer can be produced.

In the modified procedure according to FIGS. 12 to 16, the material removal unit 12 has an applicator 16 for a liquid, such as a solvent. Before the material removal unit 12 is moved between component 11 and trough 1, the liquid is applied to the surface of the material removal unit 12, so that a soaked layer 17 is formed (FIG. 13). The adhering amount of material 13 is then at least partially transferred from the component layer with the aid of the layer 17 (FIG. 15), so that the amount of material 13′ gests on the material removal unit 12.

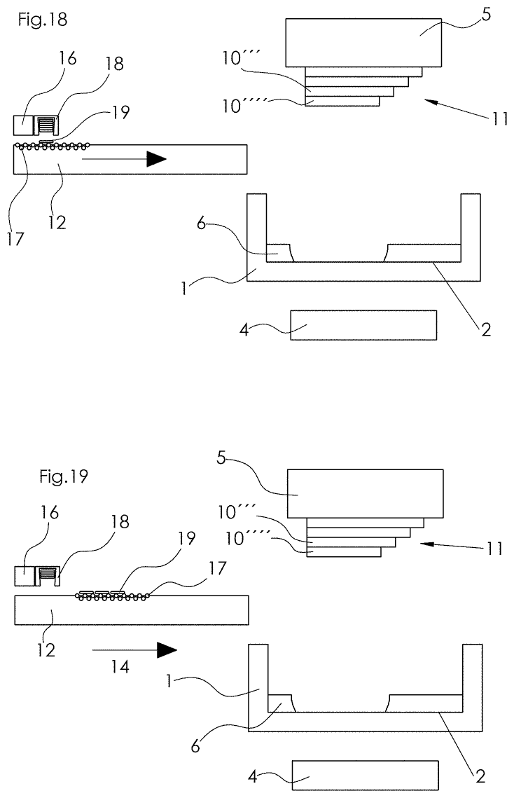

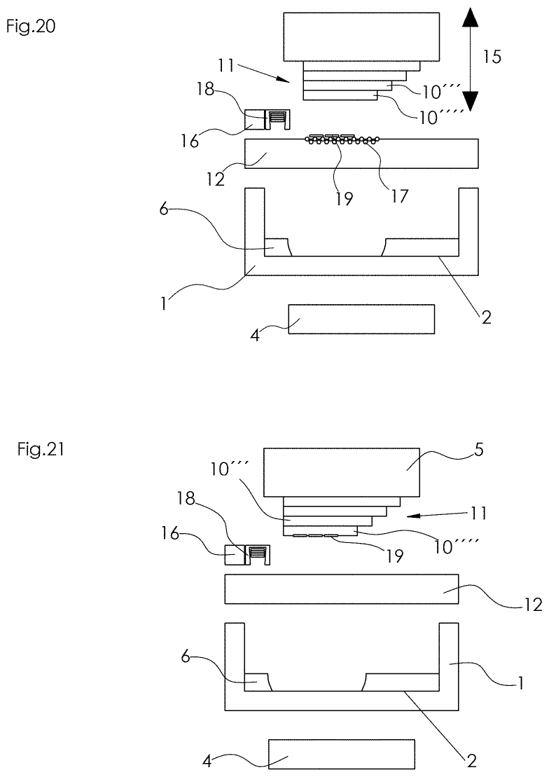

In the embodiment according to FIGS. 17 to 21, the material removal unit 12 or a separate unit is used to apply particles 19 to the cleaned component layer 10′″″ before the next component layer is produced. As shown in FIG. 17, an applicator 18 is provided for this purpose, which applies particles 19 to the material removal unit 12 (FIG. 18). The applicator 16 preferably also applies a liquid, so that an impregnated layer 17 is formed. After the material removal unit 12 has been brought between the component 11 and the trough 1 (FIG. 20), by bringing the material removal unit 12 and the component layer 10″″ into contact perpendicularly, the particles 19 transfer to the component layer 10″″, such as shown in FIG. 21.

FIGS. 22 to 31 show an example of a method with which a component layer can be produced from two different photopolymerizable materials. For this purpose, a modified device is used which, compared to the preceding examples, has a second material trough 20 with a material carrier 21, in which a second material 22 is received.

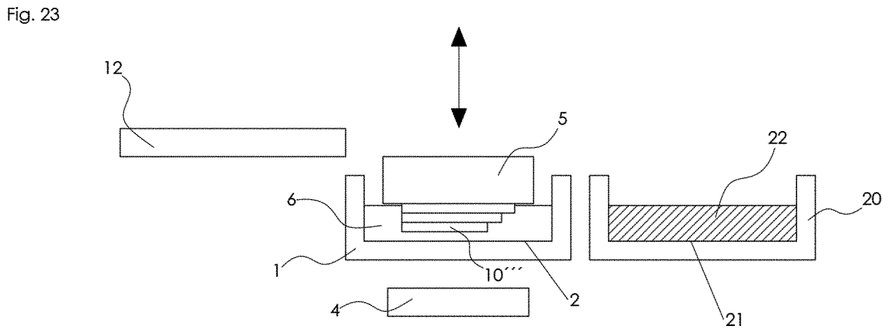

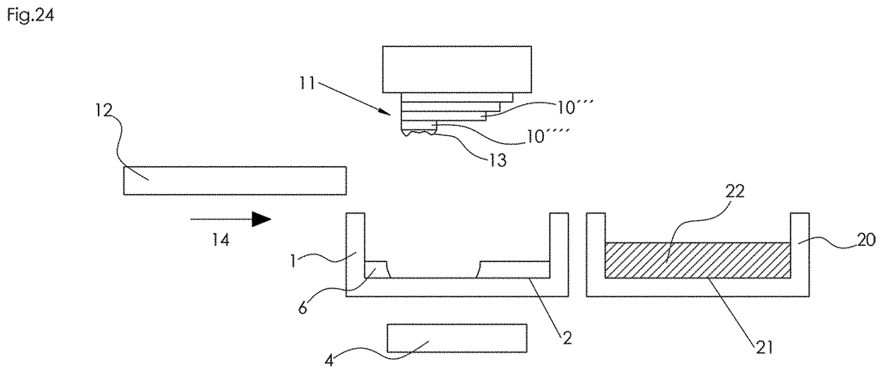

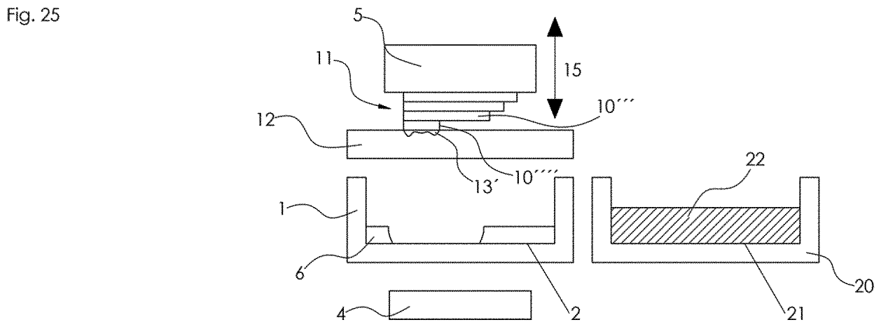

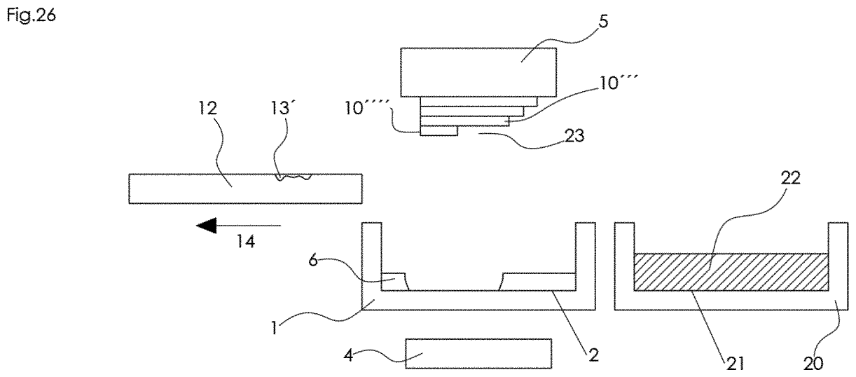

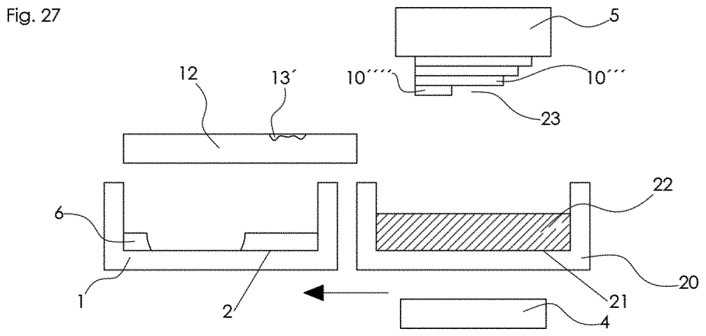

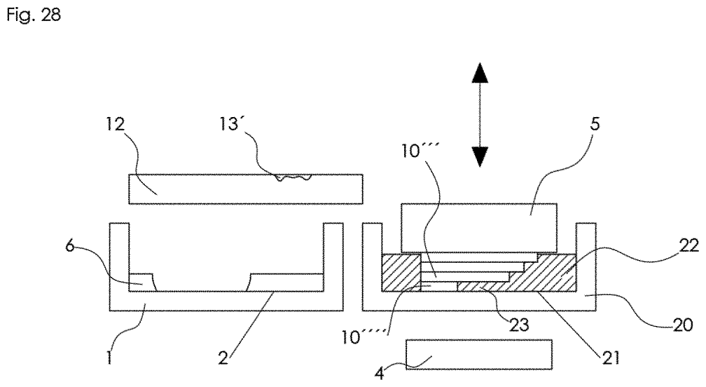

First, a first component layer 10′″ is produced by dipping the component into the material 6 located in the trough 1 and curing the material 6 (FIG. 23). After the component 11 has been lifted (FIG. 24), a quantity of material 13 adheres again to the component layer 10″″ built up last, and as already described, the quantity of material 13′ is transferred to the material removal unit 12 (FIGS. 25 and 26). In FIG. 26 it can be seen that the component layer 10″″ leaves a partial area 23 of the component layer 10′″ uncovered. A layer of the second material 22 is now produced in this sub-area 23 by first moving the first trough 1 horizontally and instead arranging the second trough 20 between the component 11 and the exposure unit 4 (FIG. 27). The component 11 is then dipped into the second material 22 until the component layer 10 produced previously touches the material carrier 2, so that a material layer is formed in the sub-area 23 which is cured (FIG. 28). Since the adhering amount of material 13 of the first material 6 is previously at least partially transferred to the material removal unit 12 so that the material amount 13′ gets on the material removal unit 12, it is avoided that the material 6 mixes with the material 22 when it is immersed in the trough 20. Furthermore, it is avoided that the previously adhering amount of material 13 is also hardened by the last-mentioned layer building process and falsifies the geometry to be formed.

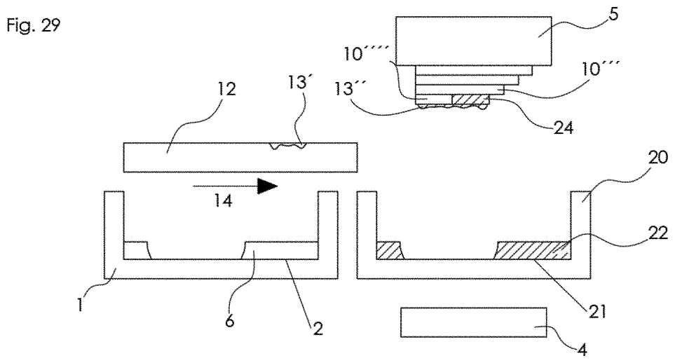

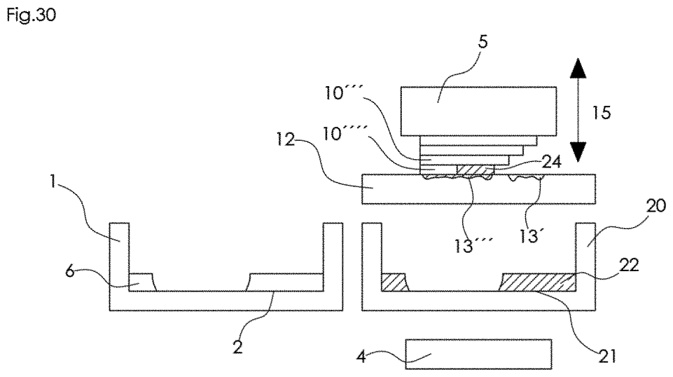

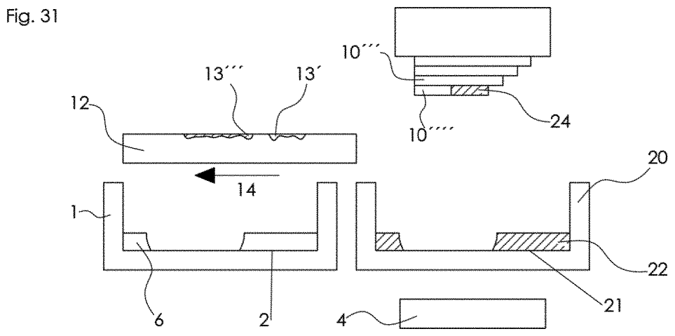

The partial layer 24 produced from the second material 22 can be seen in FIG. 29. The amount of material 13″ adhering to the last component layer is again at least partially transferred to the material removal unit 12 so that the material amount 13′″ gets on the material removal unit 12 (FIGS. 30 and 31).

FIG. 32 shows a preferred embodiment of the material removal unit 12. The material removal unit 12 comprises a displaceable belt 25 which is unrolled from a supply roll 26 and rolled onto the receiver roll 27. In between, the movable belt 25 is guided around several deflection and pressure rollers, with a section of the belt 25 located between the rollers 28 and 29 forming the contact section which is brought into contact with the component layer in order to at least partially transfer the adhering amount of material 13 onto the material removal unit 12, so that the amount of material 13′ gets on the material removal unit 12. The movable belt 25 can consist of an absorbent material, in particular based on cellulose.

FIG. 33 shows an alternative embodiment of the material removal unit 12, with which the adhering amount of material 13 is at least partially removed or sucked off pneumatically. For this purpose, the material removal unit 12 comprises a first channel 30 for a gas which, using the Venturi effect, generates a negative pressure at the confluence of the channel 32. Another channel 31 opens out on the surface of the material removal unit 12 and generates a gas jet directed against the adhering amount of material 13. In order to prevent the adhering amount of material 13 from being pressed into the component 11, an overpressure is also generated on the underside of the component by generating a gas pressure via bores 33 (or other cavities) formed in the component 11 and the building platform 5, which leads adhering amount of material 13 in the direction of the channel 32.

1-18. (canceled)

19. A method of building up a component layer by layer from a photopolymerizable material, comprising successively forming component layers one on top of the other comprising the steps of:
forming a material layer of the photopolymerizable material on a material carrier,
lowering a building platform or the component at least partially built up on the building platform into the material layer, so that a layer of the photopolymerizable material is formed between the building platform or the component and the material carrier,
curing the layer of the photopolymerizable material in a location-selective manner by irradiation through the material carrier to form the desired geometry of the component layer,
lifting the component with the component layer,
wherein the method further comprises carrying out a material removal step after the formation of the component layer, which comprises at least partially removing photopolymerizable material adhering to the component that is not or not fully cured after the component has been lifted by means of a material removal unit.

20. The method according to claim 19, wherein the material removal step comprises bringing the adhering photopolymerizable material into contact with an absorbent contacting element.

21. The method according to claim 19, wherein the material removal unit for the material removal step is brought between the lifted component and the material carrier.

22. The method according to claim 19, wherein the component is rotated to the side for the material removal step after having been lifted.

23. The method according to claim 20, wherein the contacting element is designed as a movable belt, the belt being moved after a material removal step in order to convey away a belt section with photopolymerizable material on it and provide a new belt section for a further material removal step.

24. The method according to claim 19, wherein the material removal step is carried out in at least two steps, with a partial amount of the adhering photopolymerizable material being removed in a first step and a remaining amount of the adhering photopolymerizable material being removed in a second step.

25. The method according to claim 20, comprising impregnating the absorbent contacting element with a solvent before it is brought into contact.

26. The method according to claim 20, wherein after the material removal step, applying particles to the component layer, the particles being transported with the contacting element to the component layer and being applied to the component layer by bringing the contacting element into contact with the component layer.

27. The method according claim 19, wherein, after the material removal step, subjecting the component layer to an optical inspection by means of an image recording device or a 3D scanner.

28. The method according to claim 19, wherein a first component layer is formed from a first photopolymerizable material and, after the material removal step to remove the first photopolymerizable material adhering to the first component layer, a second component layer is formed from a second photopolymerizable material, which is different from the first photopolymerizable material.

29. The method according to claim 19, wherein a component layer with a first geometry is formed from a first photopolymerizable material, wherein the first geometry leaves uncovered at least a sub-area of the component layer formed last, wherein first photopolymerizable material adhering to the component layer and to the at least one uncovered sub-area is removed by means of the material removal step and wherein a building step is then carried out with a second photopolymerizable material that differs from the first photopolymerizable material, the building step comprising curing material in the sub-area.

30. The method according to claim 19, wherein the material removal step comprises creating a fluid flow in the area of the adhering, uncured photopolymerizable material which carries the material along with it.

31. A device for building up a component layer by layer from a photopolymerizable material by means of a method according to claim 19, comprising
a material carrier for photopolymerizable material, which is at least partially translucent,
a building platform which is held at an adjustable height above the material carrier,
an irradiation unit which can be controlled for the location-selective irradiation of a material layer formed between the underside of the building platform and the material carrier, whereby a component layer can be generated,
a material removal unit for at least partial removal of uncured photopolymerizable material adhering to the component after it has been lifted.

32. The device according to claim 31, wherein the material removal unit comprises an absorbent contacting element, which is arranged to be brought into contact with the adhering photopolymerizable material.

33. The device according to claim 31, wherein the material removal unit is displaceably arranged to be brought between the lifted component and the material carrier for the material removal step.

34. The device according to claim 31, wherein the building platform is rotatably supported in order to rotate the component to the side for the material removal step after the lifting.

35. The device according to claim 33, characterized in that the contacting element is designed as a movable belt.

36. The device according to claim 34, characterized in that the contacting element is designed as a movable belt.

37. The device according to claim 32, wherein the material removal unit comprises an applicator for applying a solvent or particles to the contacting element.
